(19) United States
(12) Patent Application Publication
(10) Pub. No.: US 2019/0249087 A1
(43) Pub. Date: Aug. 15, 2019

(54) EXTRACTION OF LIQUID HYDROCARBON FRACTION FROM CARBONACEOUS WASTE FEEDSTOCK

(71) Applicant: NULIFE GREENTECH INC. [CA/CA], Saskatoon (JP)

(72) Inventors: Jerry KRISTIAN, Saskatoon (CA); Brock EIDEM, Saskatoon (CA); Peter VOLDENG, Saskatoon (CA)

(21) Appl. No.: 16/331,747

(22) PCT Filed: Sep. 9, 2016
(86) PCT No.: PCT/CA2016/000228

§ 371 Date: Mar. 8, 2019

(51) Int. Cl. C10G 1/00; B01D 17/04; B01D 21/02; B09B 3/00

(52) U.S. Cl. CPC C10G 1/00; B01D 17/042; C10G 2300/1003; B09B 3/0016; B09B 3/0083; B01D 21/10

(57) ABSTRACT

A method of extraction of a liquid hydrocarbon fraction from carbonaceous waste feedstock. Waste material is slurried, by grinding or comminution of same into a substantially uniform stream of ground waste material. Fluid would be added as required to supplement the ground waste to yield a slurry of desirable parameters—the fluid used would be primarily liquid effluent fraction recovered from previous operation of the method. Feedstock slurry is placed into a pressurized heat transfer reactor where it is maintained at temperature and pressure for a predetermined period of time. On discharge from the heat transfer reactor the processed emulsion is separated into liquid hydrocarbon fraction, liquid effluent fraction and solid waste fraction. The method can be used in batch or continuous feeding modes. The useable waste stream for the method is ample and diverse—resulting in a substantial source of recovered hydrocarbon fluids. A novel heat transfer reactor design is also disclosed.

### FIELD OF THE INVENTION

The invention is in the field of waste treatment and hydrocarbon production, and more specifically comprises a method of extraction of a liquid hydrocarbon fraction from carbonaceous waste feedstock using a pressurized heat transfer process followed by fractionation of the treated processed emulsion.

### BACKGROUND OF THE INVENTION

Traditional extractive hydrocarbon production techniques are threatened in many jurisdictions, as demand increases and oil production geologies and areas are depleted or the extraction of oil is socially complicated by climate change efforts and the like. While oil and gas extraction technologies will continue to remain important sources of hydrocarbons including liquid oil, this business environment has led to opportunities and awareness for trying new and alternative methods of producing or recovering hydrocarbon energy sources from other non-traditional techniques or sources.

Recovery of hydrocarbon fractions from other wastes or feedstocks is often done by a technique referred to as hydrothermal liquefaction. Hydrothermal liquefaction is a thermal process used to convert wet biomass into a hydrocarbon or crude like oil, which is sometimes referred to as a bio crude or bio oil, by the application of temperature and high pressure. Through a hydrothermal liquefaction reaction, carbon and hydrogen in an organic material such as biomass or other wastes are thermal chemically converted into compounds having a similar characteristic to other hydrocarbons and oil. Depending upon processing conditions and downstream steps, the outcome of such an HTL process can be used as produced in heavy engine applications or can be upgraded or refined for use in transportation fuel or other similar applications. Theoretically virtually any biomass can be converted into bio oil using a hydrothermal liquefaction process, regardless of water content. However, if it were possible to use hydrothermal impaction processes on other waste streams other than traditional biomass on which the process has been tested and used, this would further expand the economic viability of the process and the availability of hydrocarbon fuel sources.

Liquid hydrocarbon fuels produced through hydrothermal liquefaction have a minimized carbon footprint, since carbon emissions produced when burning the biofuel in a net context are minimized since often times biomass or other similar feedstock is used in production of the biofuel and those consume carbon dioxide from the atmosphere. Hydrothermal liquefaction is a clean process, producing only harmless byproducts which can be neutralized, along with liquid hydrocarbon fractions. Hydrothermal liquefaction also produces a bio oil with a high energy density as compared to the outcome from other processes.

There are massive quantities of carbonaceous waste in the world from which it would be desirable to find a way to recover any available hydrocarbon fractions. In particular municipal solid waste represents a virtually limitless economic opportunity if there were some method of hydrocarbon recovery that could be used to recover hydrocarbons from such a waste stream. It is the goal of the present invention to develop a means of streamlined and economic extraction of a liquid hydrocarbon fraction from municipal solid waste, industrial and commercial waste and similar waste streams containing carbon.

One of the areas in which work has been done is the production or extraction of liquid hydrocarbon or bio-oil from waste feedstocks comprising in large part a fraction of algae which are grown for this purpose. For example, U.S. patent application Ser. No. 13/696790 to Bathurst relates to the treatment of an algae feedstock to recover a hydrocarbon from a carbonaceous waste stream. That method however is one of many that contemplates recovery of oil from an algae-driven waste processing method. An alternate method of oil recovery from carbonaceous waste streams which did not include the need to first subject the waste stream to an algae growth or consumption step would be considered desirable.

One primary limitation to the economic utility of algae based waste processing techniques to recover oil therefrom is the fact that massive quantities of clean water are required and consumed in such processes, to grow the algae and subject it to additional processing. If a method of processing carbonaceous municipal solid waste and other similar waste streams to recover a hydrocarbon fraction therefrom existed which did not require the ongoing consumption of significant quantities of clean water, it is believed that this would further enhance the attractiveness of such alternate methods.

Many of the prior art methods for recovery of oil from carbonaceous waste feedstocks rely in part on a heat treatment step. Heat transfer and recovery in the most efficient way possible is a primary economic viability factor in considering the adoption of many of these methods—one of the limitations to many of these prior art attempts to recover liquid hydrocarbon fraction from carbonaceous waste feedstock include the size and efficiency of the heat reactors developed and used for this process. Reactors of small size have only ever been developed, limiting the throughput of the processes in question and their economic viability. If it were possible to design a heat transfer reactor that allowed for a significant increase in volume or throughput in a heat-based method of extraction of a liquid hydrocarbon fraction from carbonaceous waste feedstock this would be an important commercial development.

In addition to efficiency and size of a heat transfer vessel, the economics of current recovery methods are also limited by virtue of the physical footprint of the required treatment equipment. Equipment of sufficient size to treat large volumes of carbonaceous waste feedstock is very large, limiting the attraction of its use.

A method of extraction of a liquid hydrocarbon fraction from carbonaceous waste feedstock which was efficient enough to process large volumes of carbonaceous waste feedstock efficiently, while protecting the environment by using as little fresh water as possible, is believed would be commercially accepted as a significant advance in waste treatment and hydrocarbon recovery techniques.

### BRIEF SUMMARY

The present invention comprises a novel method of extraction of a liquid hydrocarbon fraction from carbonaceous waste feedstock such as municipal solid waste which allows for the recovery of a liquid hydrocarbon fraction from the carbonaceous waste feedstock with minimal pre-processing, and without the need for a first bio-consumption or bio-processing step using algae or the like. Processing of the waste feed stream in a slurry comprised of comminuted carbonaceous waste feedstock and recycled liquid effluent fraction from the process minimizes the need for the use of clean water in processing.

It is specifically contemplated that the method of the present invention, while being effective with the use of many different types of heat transfer reactors and tube reactors, could be accomplished using a heat transfer reactor with a “out and back” design, which more specifically comprises an outer heating tube having an outer tube length and an outer tube diameter, and a closed outer distal end of the discharge end, along with an inner heating tube which has an inner tube length and an inner tube diameter, along with an injection end and an open inner distal end. The inner volume of the inner feeding tube would comprise an inner heating reservoir. The inner tube diameter is smaller than the outer tube diameter, such that when the inner heating tube is placed within the outer heating tube, the space between the inner heating tube and the outer heating tube is an outer heating reservoir, and the inner heating tube is mounted axially inside of the outer heating tube with the injection end of the inner feeding tube being in proximity to the discharge end of the outer heating tube, and the inner distal end of the inner heating tube is in proximity to the inside of the outer distal end of the outer heating tube. This configuration of the inner heating tube and the outer heating tube results in the “out and back” slurry path design referenced above, where slurry pumped into the inner heating tube will travel through the inner heating tube and then back through the outer heating reservoir when discharged from the inner distal end of the inner heating tube.

In addition to this configuration of the outer heating tube and the inner heating tube, defining inner and outer heating reservoirs, the heat transfer reactor of these embodiments of the method of the present invention would also include pressure controlling injection means connected to the injection end of the inner heating tube through which feedstock slurry can be injected into the inner heating reservoir, and pressure controlling discharge means connected to the discharge end of the outer heating tube from which processed emulsion can be discharged from the outer heating reservoir. The pressure controlling injection means and pressure controlling discharge means will operate cooperatively to maintain the selected pressure of feedstock slurry within the heat transfer reactor during the heating step.

A source of feedstock slurry will be operatively connected to the pressure controlling injection means, and a heat source will be in operative communication with the outer heating reservoir whereby heat can be applied to the feedstock slurry within the heat transfer reactor, and heat from the heating source will translate through the outer heating reservoir to the inner heating reservoir as well.

As outlined above, different types of tube reactor designs will be understood to those skilled in the art, but is specifically contemplated that the heat source in operative communication with the outer heating reservoir comprises a fluid heat exchange jacket around the exterior of at least a portion of the outer heating tube, wherein the heating fluid circulated therethrough will transfer heat to the outer heating tube into the feedstock slurry within the transfer reactor. The heating fluid could be heated oil or some other type of fluid. In other cases, rather than heating fluid, heating elements or other heat sources can be used to provide heat for application in a heat exchange application and all such approaches are contemplated herein.

The fluid heat exchange jacket would likely be operatively connected to a heated fluid reservoir via a pump for circulation therethrough and reheating of the heating fluid on recirculation back to the heated fluid reservoir.

The pressure controlling injection means likely comprises a pumping apparatus and an injection valve connected to the inner heating tube. The pressure controlling discharge means likely comprises a discharge valve. The injection valve and the discharge valve can be cooperatively operated to permit the injection of slurry into the system and its discharge therefrom while maintaining the selected pressure within the reactor during the heating step.

As outlined above it will be understood that various types of heat transfer reactors could be designed that accomplish the objective of the present invention but the method is contemplated to be of particular efficiency with the out and back dual tube reactor design outlined above.

In addition to the method of extraction of a liquid hydrocarbon fraction from carbonaceous waste feedstock outlined herein, the invention as disclosed also comprises a heat transfer reactor design for use in such a method. Specifically, a heat transfer reactor for use in a method of extraction of a liquid hydrocarbon fraction from carbonaceous waste feedstock where the method comprises a grinding step, comprising the grinding of carbonaceous waste feedstock into ground feedstock of a selected particle size; a slurrying step which comprises the creation of feedstock slurry by combining the ground feedstock with a slurry fluid as required to yield a feedstock slurry of the desired consistency and moisture content; a heating step comprising the placement of the feedstock slurry into a heat transfer reactor and heating the feedstock slurry to a selected heating temperature for selected period of heating time while maintaining a selected pressure within the heat transfer reactor, following the completion of which the feedstock slurry is processed emulsion which is discharged from the heat transfer reactor; and a fractionation step which comprises the separation of the processed emulsion into three fractions namely a liquid hydrocarbon fraction, liquid effluent fraction and a solid waste fraction. The heat transfer reactor itself comprises an outer heating tube having an outer tube length and an outer tube diameter, and a closed outer distal end and the discharge end.

Also included is an inner heating tube having an inner tube length and an inner tube diameter, and an injection and an open inner distal end, the inner volume of the inner heating tube comprising an inner heating reservoir, and wherein the inner tube diameter is smaller than the outer tube diameter such that when the inner tube diameter is mounted inside of the outer heating tube the space between the inner heating tube and the outer heating tube comprises an outer heating reservoir, and the inner heating tube is mounted axially inside of the outer heating tube with the injection end of the inner heating tube being near the discharge end of the outer heating tube, and the inner distal end of the inner heating tube being in proximity to the inside of the outer distal end of the outer heating tube whereby feedstock slurry injected into the inner heating reservoir via the injection end will exit the inner heating reservoir under pressure and be pressured back along the outer heating reservoir towards the discharge end. Additionally the heat transfer reactor of the present invention comprises a pressure controlling injection means which is connected to the injection end of the inner heating tube through which feedstock slurry can be injected into the inner heating reservoir, and pressure controlling discharge means connected to the discharge end of the outer heating tube from which processed emulsion can be discharged from the outer heating reservoir and wherein the pressure controlling injection means and the pressure controlling discharge means operate cooperatively to maintain the selected pressure of feedstock story within the heat transfer reactor during the heating step. Finally, the heat transfer reactor would also include a heat source in operative communication with the outer heating reservoir whereby heat can be applied to feedstock slurry within the heat transfer reactor.

Variations of the heat transfer reactor outlined above with respect to the method of the present invention are also contemplated to be covered with respect to the heat transfer reactor design and the apparatus disclosed herein. The heat transfer reactor could for example as a heating source use a fluid heat exchange jacket around the exterior of at least a portion of the outer heating tube, connectable to a heating fluid source, wherein the heating fluid circulated therethrough will transfer heat to the outer heating tube into the feedstock story within the heat transfer reactor. The heating fluid source connected thereto might comprise a heating fluid reservoir and a pump, whereby heating fluid such as heating oil or the like could be circulated through the fluid heat exchange jacket and back to the reservoir for reheating. In other cases, rather than heating fluid, heating elements or other heat sources can be used to provide heat for application in a heat exchange application and all such approaches are contemplated herein.

The diameter and sizing of the components of the heat transfer reactor could vary but it is specifically contemplated that an outer tube diameter of at least 4 inches would provide for a heat transfer reactor design that would allow for significant and economical processing volumes.

The pressure controlling injection means could comprise an injection valve connected to a pump and/or reservoir or slurry source. The pressure controlling discharge means could comprise a discharge valve.

The heat transfer reactor of the present invention could in some embodiments operate in a batch feeding mode and in other embodiments operate in the continuous feeding mode and both such approaches are contemplated within the scope of the present invention.

It is specifically contemplated that the method of the present invention, while being effective with the use of many different types of heat transfer reactors and tube reactors, could be accomplished using a heat transfer reactor with a “out and back” design, which more specifically comprises an outer heating tube having an outer tube length and an outer tube diameter, and a closed outer distal end of the discharge end, along with an inner heating tube which has an inner tube length and an inner tube diameter, along with an injection end and an open inner distal end. The inner volume of the inner feeding tube would comprise an inner heating reservoir. The inner tube diameter is smaller than the outer tube diameter, such that when the inner heating tube is placed within the outer heating tube, the space between the inner heating tube and the outer heating tube is an outer heating reservoir, and the inner heating tube is mounted axially inside of the outer heating tube with the injection end of the inner feeding tube being in proximity to the discharge end of the outer heating tube, and the inner distal end of the inner heating tube is in proximity to the inside of the outer distal end of the outer heating tube. This configuration of the inner heating tube and the outer heating tube results in the “out and back” slurry path design referenced above, where slurry pumped into the inner heating tube will travel through the inner heating tube and then back through the outer heating reservoir when discharged from the inner distal end of the inner heating tube.

In addition to this configuration of the outer heating tube and the inner heating tube, defining inner and outer heating reservoirs, the heat transfer reactor of these embodiments of the method of the present invention would also include pressure controlling injection means connected to the injection end of the inner heating tube through which feedstock slurry can be injected into the inner heating reservoir, and pressure controlling discharge means connected to the discharge end of the outer heating tube from which processed emulsion can be discharged from the outer heating reservoir. The pressure controlling injection means and pressure controlling discharge means will operate cooperatively to maintain the selected pressure of feedstock slurry within the heat transfer reactor during the heating step.

A source of feedstock slurry will be operatively connected to the pressure controlling injection means, and a heat source will be in operative communication with the outer heating reservoir whereby heat can be applied to the feedstock slurry within the heat transfer reactor, and heat from the heating source will translate through the outer heating reservoir to the inner heating reservoir as well.

As outlined above, different types of tube reactor designs will be understood to those skilled in the art, but is specifically contemplated that the heat source in operative communication with the outer heating reservoir comprises a fluid heat exchange jacket around the exterior of at least a portion of the outer heating tube, wherein the heating fluid circulated therethrough will transfer heat to the outer heating tube into the feedstock slurry within the transfer reactor. The heating fluid could be heated oil or some other type of fluid. In other cases, rather than heating fluid, heating elements or other heat sources can be used to provide heat for application in a heat exchange application and all such approaches are contemplated herein.

The fluid heat exchange jacket would likely be operatively connected to a heated fluid reservoir via a pump for circulation therethrough and reheating of the heating fluid on recirculation back to the heated fluid reservoir.

The source of feedstock slurry likely comprises a slurry reservoir.

To process significant volumes of feedstock slurry, the outer tube diameter would likely be at least 4 inches. This being said the outer tube diameter could be really any measurement without departing from the scope of the present invention as outlined.

The pressure controlling injection means likely comprises a pumping apparatus and an injection valve connected to the inner heating tube. The pressure controlling discharge means likely comprises a discharge valve. The injection valve and the discharge valve can be cooperatively operated to permit the injection of slurry into the system and its discharge therefrom while maintaining the selected pressure within the reactor during the heating step.

As outlined above it will be understood that various types of heat transfer reactors could be designed that accomplish the objective of the present invention but the method is contemplated to be of particular efficiency with the out and back dual tube reactor design outlined above.

In addition to the method of extraction of a liquid hydrocarbon fraction from carbonaceous waste feedstock outlined herein, the invention as disclosed also comprises a heat transfer reactor design for use in such a method. Specifically, a heat transfer reactor for use in a method of extraction of a liquid hydrocarbon fraction from carbonaceous waste feedstock where the method comprises a grinding step, comprising the grinding of carbonaceous waste feedstock into ground feedstock of a selected particle size; a slurrying step which comprises the creation of feedstock slurry by combining the ground feedstock with a slurry fluid as required to yield a feedstock slurry of the desired consistency and moisture content; a heating step comprising the placement of the feedstock slurry into a heat transfer reactor and heating the feedstock slurry to a selected heating temperature for selected period of heating time while maintaining a selected pressure within the heat transfer reactor, following the completion of which the feedstock slurry is processed emulsion which is discharged from the heat transfer reactor; and a fractionation step which comprises the separation of the processed emulsion into three fractions namely a liquid hydrocarbon fraction, liquid effluent fraction and a solid waste fraction. The heat transfer reactor itself comprises an outer heating tube having an outer tube length and an outer tube diameter, and a closed outer distal end and the discharge end. Also included is an inner heating tube having an inner tube length and an inner tube diameter, and an injection and an open inner distal end, the inner volume of the inner heating tube comprising an inner heating reservoir, and wherein the inner tube diameter is smaller than the outer tube diameter such that when the inner tube diameter is mounted inside of the outer heating tube the space between the inner heating tube and the outer heating tube comprises an outer heating reservoir, and the inner heating tube is mounted axially inside of the outer heating tube with the injection end of the inner heating tube being near the discharge end of the outer heating tube, and the inner distal end of the inner heating tube being in proximity to the inside of the outer distal end of the outer heating tube whereby feedstock slurry injected into the inner heating reservoir via the injection end will exit the inner heating reservoir under pressure and be pressured back along the outer heating reservoir towards the discharge end. Additionally the heat transfer reactor of the present invention comprises a pressure controlling injection means which is connected to the injection end of the inner heating tube through which feedstock slurry can be injected into the inner heating reservoir, and pressure controlling discharge means connected to the discharge end of the outer heating tube from which processed emulsion can be discharged from the outer heating reservoir and wherein the pressure controlling injection means and the pressure controlling discharge means operate cooperatively to maintain the selected pressure of feedstock story within the heat transfer reactor during the heating step. Finally, the heat transfer reactor would also include a heat source in operative communication with the outer heating reservoir whereby heat can be applied to feedstock slurry within the heat transfer reactor.

Variations of the heat transfer reactor outlined above with respect to the method of the present invention are also contemplated to be covered with respect to the heat transfer reactor design and the apparatus disclosed herein. The heat transfer reactor could for example as a heating source use a fluid heat exchange jacket around the exterior of at least a portion of the outer heating tube, connectable to a heating fluid source, wherein the heating fluid circulated therethrough will transfer heat to the outer heating tube into the feedstock story within the heat transfer reactor. The heating fluid source connected thereto might comprise a heating fluid reservoir and a pump, whereby heating fluid such as heating oil or the like could be circulated through the fluid heat exchange jacket and back to the reservoir for reheating. In other cases, rather than heating fluid, heating elements or other heat sources can be used to provide heat for application in a heat exchange application and all such approaches are contemplated herein.

The diameter and sizing of the components of the heat transfer reactor could vary but it is specifically contemplated that an outer tube diameter of at least 4 inches would provide for a heat transfer reactor design that would allow for significant and economical processing volumes.

The pressure controlling injection means could comprise an injection valve connected to a pump and/or reservoir or slurry source. The pressure controlling discharge means could comprise a discharge valve.

The heat transfer reactor of the present invention could in some embodiments operate in a batch feeding mode and in other embodiments operate in the continuous feeding mode and both such approaches are contemplated within the scope of the present invention.

### BRIEF DESCRIPTION OF THE DRAWINGS

To easily identify the discussion of any particular element or act, the most significant digit or digits in a reference number refer to the figure number in which that element is first introduced. The drawings enclosed are:

FIG. 1 is a flow chart demonstrating the steps of one embodiment of the method of extraction of a liquid hydrocarbon fraction from carbonaceous waste feedstock outlined herein;

FIG. 2 is a flow chart demonstrating the steps of an alternate embodiment of the method of extraction of a liquid hydrocarbon fraction from carbonaceous waste feedstock outlined herein;

FIG. 3 illustrates one embodiment of a heat transfer reactor and related equipment which could be used in accordance with the present invention;

FIG. 4 is a cutaway cross-sectional view of the heat transfer reactor of FIG. 3;

FIG. 5 illustrates an alternate embodiment of a heat transfer reactor and related equipment which could be used in accordance with the present invention; and

FIG. 6 is a cutaway cross-sectional view of the heat transfer reactor of FIG. 5.

### DETAILED DESCRIPTION OF ILLUSTRATED EMBODIMENTS

As outlined above the general focus of the present invention is to provide a novel method of extraction of a liquid hydrocarbon fraction from carbonaceous waste feedstock such as municipal solid waste, which allows for the recovery of a liquid hydrocarbon fraction from carbonaceous waste feedstock with minimal waste removal, and without the need for a first bio-consumption or bio-processing step using algae or the like. Processing of such a waste feed stream in a slurry comprised of particulate or ground carbonaceous waste feedstock and recycled liquid effluent fraction from the process minimizes the need for the use of clean water in processing.

Overall the method of the present invention is a method of hydrothermal liquefaction, comprising the creation of a feedstock slurry, by combining carbonaceous waste feedstock which is ground to a selected particle size with slurry fluid as required to yield a feedstock slurry of a desired moisture content and consistency. The feedstock slurry is then placed within a pressurized heat reactor vessel, where it is subjected to a heating reaction for a predetermined period of time and at a predetermined pressure level within the heat reactor to a particular heated temperature. Following the elapse of the selected period of time within which the heating step is undertaken, transformation will have taken place within the feedstock slurry, which is now processed emulsion, such that there are three fractions capable of segregation or fractionation therefrom—being a liquid hydrocarbon fraction, the highest economic value fraction, along with a liquid effluent fraction which in most embodiments of the invention would primarily constitute water, and the solid waste fraction. Specifics of the separation of the fractions in the processed emulsion will be understood by those skilled in the art.

In addition to the overall novel method that is presented herein, the heat reactor vessel and the overall system which is used in the practice of the method is also novel and disclosed and is intended to be encompassed within the scope of the subject matter and the invention outlined herein.

General Method Overview:

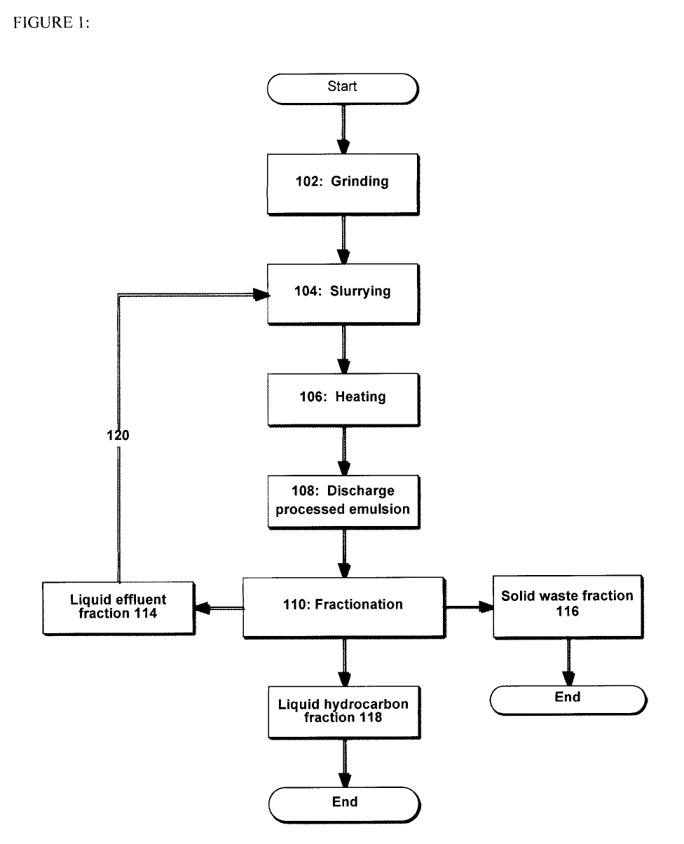

Referring first to FIG. 1, there is shown a flowchart outlining the steps in one basic embodiment of the method of the present invention. The first step of the method of the present invention is a grinding step 102, in which the selected carbonaceous waste feedstock is ground into a ground feedstock of a selected particle size. Various types of grinding equipment could be used to accomplish this step, depending upon the original format, phase or hardness for example of the carbonaceous waste feedstock, and the varying types of grinding equipment available or other equipment which can be used to process a carbonaceous waste feedstock into a ground feedstock of a particular selected particle size will be understood to those skilled in the art and are all contemplated within the scope of the present invention. In some cases, grinding the carbonaceous waste feedstock into a ground feedstock of the selected particle size will also result in the completed creation of a feedstock slurry at the desired consistency and moisture content. In other cases, the specific slurrying step which is next described will be required. All such approaches are contemplated within the scope of the present invention.

With the ground feedstock of the selected particle size having been prepared, the next step in the method, shown at block 104, is a slurrying step. The slurrying step consists of the creation of a feedstock slurry by combining the ground feedstock with a slurry fluid as required, to yield a feedstock slurry of the desired consistency and moisture content. The desired consistency and moisture content could be determined on a case-by-case basis or may be dictated by other process parameters—the creation of a feedstock slurry by the combination of a ground particulate waste stream with a slurry fluid will be easily understood by those skilled in the art, and many combinations of equipment and method sub-steps which accomplish this objective of mixing those two components into a homogenous feedstock slurry for further processing are contemplated within the scope of the present invention.

One of the key distinguishing factors of the present invention as outlined herein is that the slurry fluid which will be used in the preparation of the feedstock slurry in the slurrying step will be recovered water which is used from previous batch processes in accordance with the present method. Clean water would really only be required in the system intermittently and on startup and once sufficient water was in the system to be recovered and reused, significant quantities of clean water would not be required.

Following the slurrying step 104, the next step in the method of the present invention is a heating step in which the feedstock slurry is subjected to a heating reaction by application of heat to a selected heating temperature at a fixed pressure and for a fixed period of time, to yield a fractionable processed emulsion containing a liquid hydrocarbon fraction. In the heating step, shown at step 106 in this Figure, the feedstock slurry is injected into a heat transfer reactor in which it is pressurized and heat applied thereto to a selected heating temperature and pressure for a fixed period of time. Following the completion of the heating of the feedstock slurry at the selected pressure and selected heating temperature for the selected timeframe, the feedstock slurry is processed emulsion, which is discharged from the heat transfer reactor for fractionation. The discharge of the processed emulsion from the heat transfer reactor is shown at step 108. The processed emulsion will be discharged from the heat transfer reactor at or near the selected heating temperature, and at the selected operating pressure within the reactor vessel.

Following is the fractionation step 110 in which the processed emulsion recovered from the heat transfer reactor is separated into three fractions, being a liquid effluent fraction 114, liquid hydrocarbon fraction 118, and a solid waste fraction 116. Various types of methods and equipment can be used to fractionate the processed emulsion—fractionation of liquid processed emulsion will be understood by those skilled in the art and it may include the use of centrifugal force, solvent scrubbing, electroseparation or other types of processing to divide the processed emulsion into the three outlined fractions. The liquid effluent fraction 114, once recovered, is used in the slurrying step 104—the loopback use of the liquid effluent fraction 114 as the slurry fluid is shown along the line 120 of the Figure.

The liquid hydrocarbon fraction 118 recovered is economically viable hydrocarbon or oil that can be used in conventional hydrocarbon applications, as recovered or following further treatment.

The solid waste fraction 116 would be useable for certain economical purposes, and is minimized and recovered efficiently in accordance with the invention such that even if it is discarded the quantity is minimized.

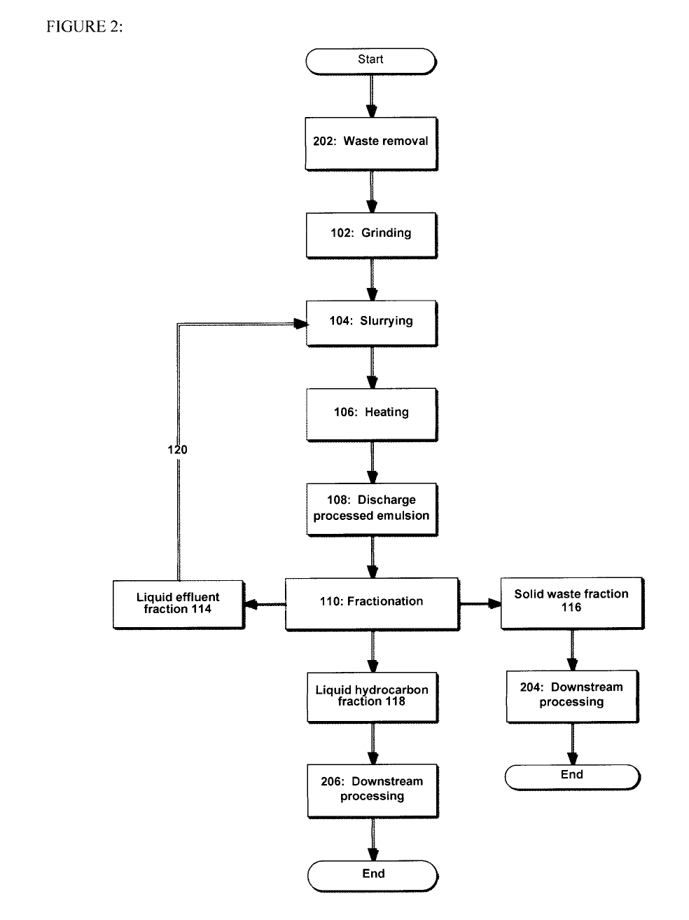

Referring now to FIG. 2 there is shown a flowchart demonstrating the steps of an alternate embodiment of the method of the present invention. At the beginning of the flowchart of FIG. 2, there is shown a waste removal step 202. Waste removal as outlined elsewhere herein might comprise the removal of undesirable components from the carbonaceous waste feedstock that it was not desired to process further in accordance with the method of the present invention.

In certain other embodiments components may be added to the carbonaceous waste feed stream in advance of the heating step—for example if it was desired to add one or more ingredients or catalysts or the like to facilitate or enhance the heating reaction that eventually takes place in the heating step to maximize the efficiency and recovery of liquid hydrocarbon fraction therefrom.

Following the waste removal step, shown at 202, FIG. 2 shows the grinding step 102 which is the grinding of the feedstock into a ground feedstock of a selected particle size. Once the ground feedstock of a selected particle size has been prepared in grinding step 102, the slurrying step 104 can be completed. The slurrying step as outlined with respect to FIG. 1 comprises the addition as required of slurry fluid, which is liquid effluent fraction recovered from previous operation of the method, to yield a feedstock slurry of the ground feedstock which was of a desired moisture content and consistency.

The heating step 106 consists of the injection or placement of the feedstock slurry into the heat transfer reactor, for the application of heat to a selected heating temperature at a selective pressure and for a selected period of time. Following the completion of the heating step, the feedstock slurry is processed emulsion. The processed emulsion is ejected from the heat reactor vessel at or near operating pressure. Some prior art HTL extraction methods explicitly contemplate cooling the processed emulsion to the ambient temperature of the environment around the equipment in advance of discharge. It is explicitly contemplated in this case that the utility and economics of the system of the present invention are enhanced by not cooling the processed emulsion to ambient temperature. The processed emulsion when discharged from the heat transfer reactor would be discharged at a temperature between the selected heating temperature and the ambient environmental temperature.

The processed emulsion recovered at 108 is then separated into at least three fractions of the processed emulsion in a fractionation step 110—the fractionation step 110, yielding the liquid hydrocarbon fraction 118, liquid effluent fraction 114 and solid waste fraction 116 could be done using many different types of separation equipment or separation methods as will be understood to those skilled in the art and all which are contemplated within the scope hereof. As discussed throughout this document, the liquid effluent fraction 114 is used in the creation of the feedstock slurry in the slurrying step 104. The liquid effluent fraction 114 will likely comprise mostly water, and additional clean water could be added as required to the liquid effluent fraction 114 to have enough to continue slurrying additional ground feedstock. It is contemplated that as the method is operated in a continuous feeding mode, it will very seldom be required to add any new water to the liquid effluent fraction 114—resulting in environmental and economic benefits as the liquid is reused.

The solid waste fraction 116 is shown in this case to be delivered or otherwise handled for downstream processing at step 204. The downstream processing of the solid waste fraction 116 could comprise limitless number of different types of processing steps or manufacturing steps to render useful products from the solid waste fraction 116 or to alternatively verify its inert nature or its clean nature for disposal.

The liquid hydrocarbon fraction 118, the recovery of which is the purpose of the operation of the entire method, is also shown in this case to be further downstream processed at 206. For example, if the liquid hydrocarbon fraction 118 was effectively an oil product, that oil 118 could be processed further by refinement or otherwise into hydrocarbon products which could be otherwise used. Any type of downstream processing of any of these recovered fractions is contemplated within the scope of the present invention.

Heat Transfer Reactor:

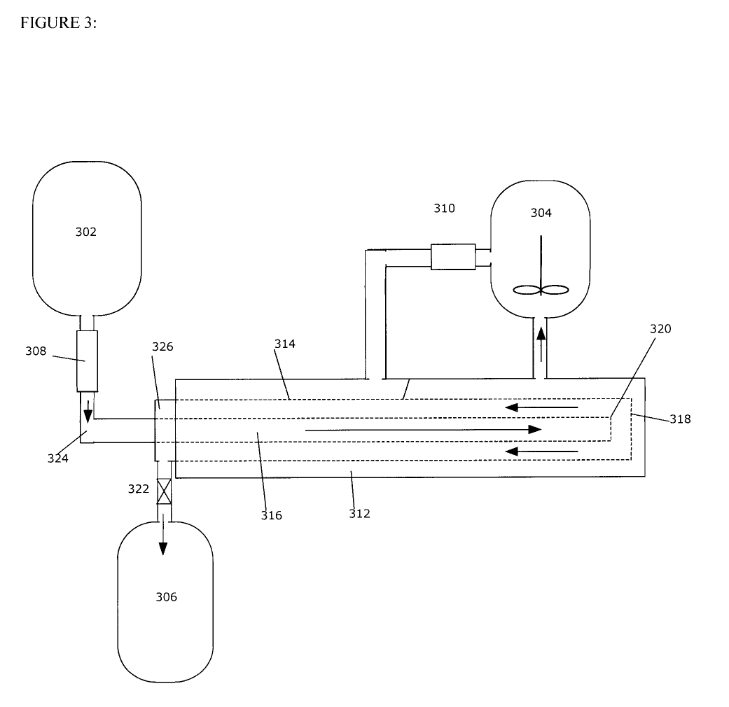

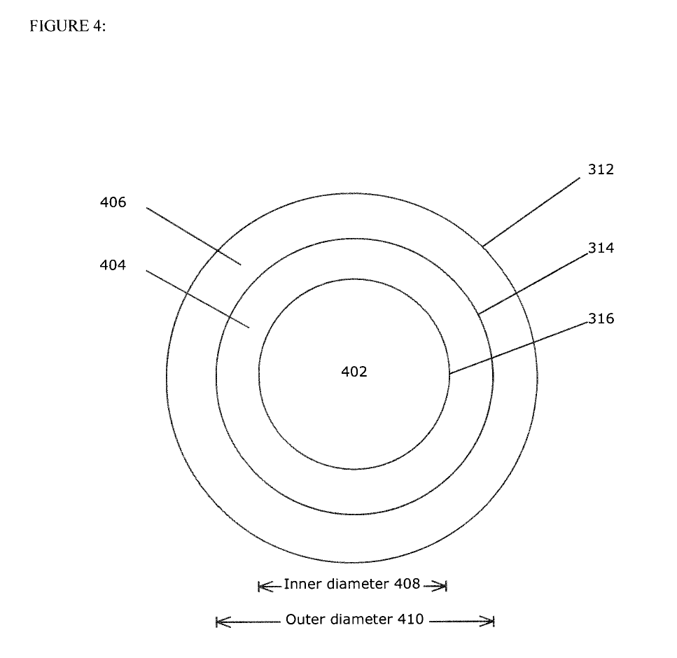

We refer first to FIG. 3 and FIG. 4 which are a schematic view of one embodiment of certain components of an embodiment of a system used in the practice of the method of the present invention. FIG. 3 is a schematic view, with FIG. 4 being a cross-sectional cutaway view of the heat transfer reactor. The key hardware element of the system is the heat transfer reactor shown. The heat transfer reactor is operably connected to a source of feedstock slurry 302 and an emulsion discharge holding tank 306, with appropriate instrumentation and controls to allow for the monitored and controlled conduct of the heating step 106 therein.

As shown in the Figures, a source of feedstock slurry 302 is demonstrated as a tank or reservoir containing the prepared feedstock slurry. As outlined elsewhere herein, the slurrying step 104 itself could either take place within the tank or vessel shown in this Figure, or alternatively the feedstock slurry could be generated, in the slurrying step 104, by in-line blending of the ground feedstock and the slurry fluid on demand and as required, for feeding into the heat transfer reactor and the heating step 106.

The heat transfer reactor itself comprises a plurality of components. The heat transfer reactor shown is a tube reactor, allowing for the ability to apply heat to feedstock slurry enclosed therein for a fixed period of time and at a fixed pressure. The first component of the heat transfer reactor shown is an outer heating tube 314 which has an outer tube length and an outer tube diameter 410, along with a closed outer distal end 318 and a discharge end 326. The second component of the heat transfer reactor in addition to the outer heating tube 314 is an inner heating tube 316 which has an inner tube length 408 and an inner tube diameter, along with an injection end 324 and an open inner distal end 320. The inner heating tube 316 is mounted axially inside of the outer heating tube 314 with the injection end 324 of the inner heating tube 314 being near the discharge end 326 of the outer heating tube 316, and the inner distal end 320 of the inner heating tube 316 is mounted inside of but near and in proximity to the inside of the outer distal end 318 of the outer heating tube 314. The inner volume of the inner heating tube 316 comprises an inner heating reservoir 402. In the “out and back” of the heat transfer reactor design shown, the inner heating tube 316 is mounted within the outer heating tube 314 by virtue of the inner tube diameter 408 being less than the outer tube diameter 410—with the space between the inner heating tube 316 and the interior surface of the outer heating tube 314 being the outer heating reservoir.

The fluid path through these assembled tubes, as shown, once there is an injection of feedstock slurry via the injection end 324 of the inner heating tube 316 is along the inner heating tube 316 and upon exiting from the inner distal end 320 of the inner heating tube 316, the feedstock slurry would be pushed back along and inside of the outer heating reservoir within the outer heating tube 314 for an additional period of heating time, before its discharge via the discharge valve 322 at the discharge end 326 of the outer heating tube 314. This type of configuration of the two components in the heat transfer reactor results in a minimized footprint and maximized effectiveness. The outer heating tube 314, near its discharge end 326, would enclose the inner heating tube 316 such that the outer heating reservoir is defined in a way that fluid can be pressured within the outer heating reservoir for discharge via the discharge valve 322.

The pressure controlling injection means which is connected to the injection end 324 of the inner heating tube 316 in this embodiment constitutes an injection valve or pump 308, through which feedstock slurry can be injected into the inner heating reservoir defined by the inner heating tube 316. The discharge valve 322 when opened would allow for the discharge of processed emulsion from the outer heating reservoir. The pressure controlling injection means and the pressure controlling discharge means, which as shown constitutes an injection valve and pump 308 and then a discharge valve 322, will be operated in cooperation to maintain the desired selective pressure of the feedstock slurry within the heat transfer reactor during the heating step 106.

The injection valve 308, which in the embodiment shown incorporates a pump, is responsible for the pressurized injection of feedstock slurry into the inner heating tube 316 and the remainder of the heat transfer reactor. The injection valve or pump 308 can be controlled or actuated appropriately to introduce the feedstock slurry into the heat transfer reactor, and the injection valve 308 can also be operated in conjunction with the discharge valve 322 to maintain the desired pressure level within the heat transfer reactor. The direction of flow of the feedstock slurry through the injection valve 308 is also shown.

The injection valve 308 again is explicitly contemplated in the embodiment shown to comprise a pump which could pump feedstock slurry from the source of feedstock slurry 302 up to pressure within the inner heating tube 316. If the source of feedstock slurry 302 were already pressurized at the appropriate operating pressure, then the injection valve 308 may not have any pressure increasing means associated therewith and may simply comprise a valve similar to the discharge valve 322.

Once the system is loaded with feedstock slurry it is explicitly contemplated that as additional slugs of feedstock slurry are injected into the system, the discharge valve 322 would be operated in conjunction to result in the discharge of slugs of processed emulsion at the same time.

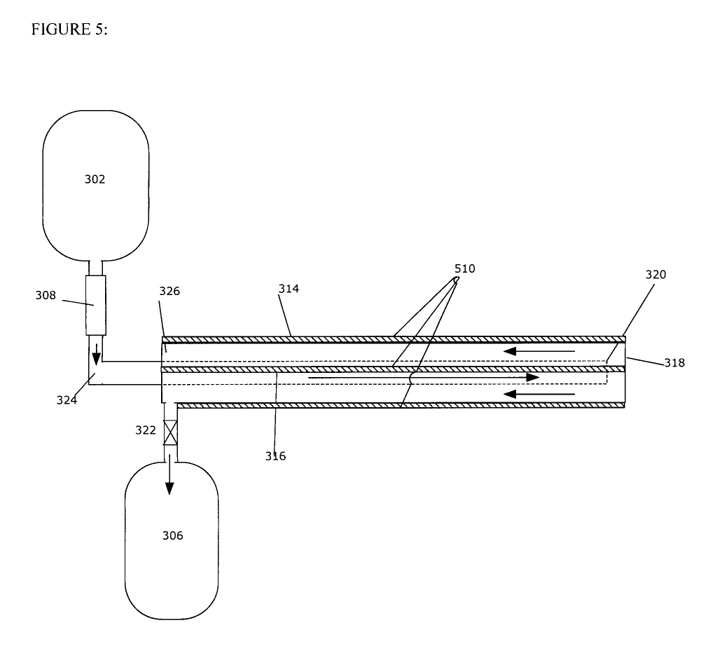

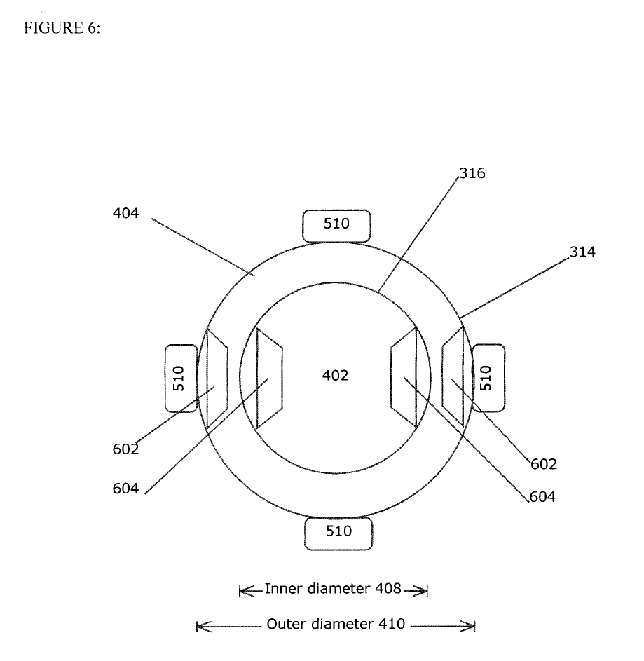

The final element of the heat transfer reactor shown in FIG. 3 is a heat source in operative communication with the outer heating reservoir defined by the outer heating tube 316, whereby heat can be applied to feedstock slurry within the heat transfer reactor. In the embodiment shown, the heat source comprises a fluid heat exchange jacket 312 in place around the outer heating tube 314, through which heating fluid can be circulated from a heating fluid reservoir 304 via a pump 310 or the like. Many different types of heat sources could be contemplated but a fluid heat exchange jacket is one which is well known in the design of heat transfer reactors and any type of a heat source which allows for the safe application of heat to feedstock slurry within the heat transfer reactor is contemplated within the scope of the present invention. Electric heating tapes or other similar heating elements could also be used, mounted outside or within the heat transfer reactor reservoirs to apply heat to feedstock slurry therein. While a fluid heating jacket is shown in the embodiment of FIG. 3, a series of four heating elements attached to the exterior of the outer heating tube is shown in the embodiment of FIG. 5 and FIG. 6. In other cases, rather than heating fluid, heating elements or other heat sources can be used to provide heat for application in a heat exchange application and all such approaches are contemplated herein.

In operation of the equipment shown in FIG. 3, the heating pump 310 would be actuated, to circulate heated heating fluid from the source of heating fluid 304 through the fluid heat exchange jacket 312. The heating fluid within the reservoir 304 could be maintained at the desired heating temperature for the feedstock slurry in accordance with the remainder of the method, or based upon additional controls and instrumentation, the heating fluid in the reservoir 304 could be maintained at a heat or temperature higher or lower than the desired eventual temperature to by virtue of application of the heat therefrom to feedstock slurry contained within the heat transfer reactor, accomplish the heating step of the method 106.

The heat transfer reactor and related equipment and components would all be instrumented such that the parameters of pressure, time within the reactor as well as the selected heating temperature could be reached and enforced during operation of the system and method.

The injection valve or pump 308 would be actuated, to inject feedstock slurry into the inner heating tube 316. Upon injection of feedstock slurry via the injection end 324 of the inner heating tube 316, once the heat transfer reactor is fully pressurized by the injection of a full load of feedstock slurry into the entirety of both the inner and outer heating reservoirs, and the desired internal pressure within the heat transfer reactor is reached, the heating step 106 can be commenced. The heating step consists of the maintenance of the feedstock slurry within the inner and outer heating reservoirs for a selected period of time at a selected heating temperature and selected pressure, until the period of time had elapsed—the discharge valve 322 can then be actuated to allow for the discharge of the processed emulsion from the heat transfer reactor. Additional piping can be used to allow for the reprocessing of the first slug or batch of slurry to go through the system when it is started up and brought to temperature etc.—this will be understood to those skilled in the art and is beyond the necessary scope of the broadest claims of the invention.

As shown in this Figure the discharge valve 322 is operatively connected to a reservoir 306 into which the processed emulsion can be captured for fractionation and completion of the method although as outlined elsewhere herein the fractionation step and the necessary fractionation equipment might actually be connected directly via the discharge valve 322 as well such that a reservoir 306 would be replaced directly with that equipment.

The most desirable operation of the heat transfer reactor outlined herein will be in a continuous feeding mode, where, dependent upon maintenance of the desired parameters for the heating step i.e. the desirable period of time for treatment of the slurry, the pressure within the vessel as well as the temperature itself, the discharge valve 322 and the injection valve or pump 308 can repeatedly be actuated to introduce additional slugs of feedstock slurry into the system and to at the same time allow for the discharge of slugs of processed emulsion via the discharge valve 322. The system and heat transfer reactor could also be operated in batch mode in certain embodiments, also considered within the scope of the present invention.

The path of travel of feedstock slurry through the inner heating tube 316 and back along the outer heating tube 314 eventually through the injection valve 322 into the processed emulsion reservoir 306 is shown by an additional series of flow arrows on the diagram. The flow of the heating fluid from the source of heating fluid 304, via the heating pump 310 through the fluid heat exchange jacket 312 is shown as well by two fluid direction arrows in the conduits associated therewith.

FIG. 4 is a cutaway cross-section of the heat transfer reactor of FIG. 3, demonstrating the various volumes and areas within the “out and back” tube reactor design contemplated. The inner heating tube 316, the outer heating tube 314, and the fluid heat exchange jacket 312 are all shown. The inner heating reservoir 402, the outer heating reservoir 404, and the heated fluid reservoir 406 in the Figure are shown.

Turning now to the embodiment of the heat transfer reactor and related equipment demonstrated in FIG. 5 and FIG. 6, there is shown a modified version of the embodiment of FIG. 3 and FIG. 4 in which agitators have been introduced—shown are a plurality of passive agitators 602 and 604, representing internal vanes, flighting or other types of passive internal fittings within the inner heating tube 316 or the outer heating tube 314 by which mixing or venturi effects could be generated within the feedstock slurry moving therethrough. Specifically, referring to the cross-sectional view of FIG. 6, there are a plurality of passive agitators shown within the inner heating reservoir 402, and similarly a plurality of agitators of the passive nature are also shown within the outer heating reservoir 404. Many different types of agitation could be used to result in a streamlined and most consistent heating pattern to be applied to the feedstock slurry within the heat transfer reactor.

Powered flighting for example could also be used within either the inner heating tube 316 or the outer heating tube 314 as might be desired, to provide a most aggressive agitation force thereon. Passive or active agitation of the feedstock slurry moving through the heat transfer reactor, or even of the heating fluid in a case where the heat source in operative communication with the outer heating reservoir was fluid heat transfer jacket connected to a heating fluid source, are all contemplated within the scope of the present invention.

The heating source shown in the embodiment of FIGS. 5 and 6 is a plurality of heating elements 510 attached to the exterior of the outer heating two. Again as outlined throughout, multiple types of heating sources can be understood and will be understood to those skilled in the art of process design such as this and any heating source capable of safely applying the required heat to feedstock slurry within the heat transfer reactor are contemplated within the scope of the present invention.

Waste Feed Stream:

As outlined in further detail elsewhere herein, various sources of carbonaceous waste feedstock could be considered for use to feed the method of the present invention. Virtually any kind of a material which contains carbon is contemplated to comprise a carbonaceous waste feedstock as outlined elsewhere herein. The primary waste streams which are contemplated to be valuable contributors to the economy of the method of the present invention are municipal solid waste, industrial waste, commercial waste or institutional waste. Any one or more of those types of waste material are considered to be key waste streams which could be processed in accordance with the method of the present invention. There are also other types of waste which could be processed in accordance with the present invention which might be more or less obvious sources of carbonaceous waste from which a liquid hydrocarbon fraction could be extracted—for example agricultural waste, plant matter, other types of household or organic waste or the like. Any type of waste feedstock that contains a carbon portion which can be liberated and recovered as a hydrocarbon fraction in accordance with the hydrothermal liquefaction method of the present invention is contemplated within the scope hereof. The singular or combined waste feedstocks are the waste feed stream which could be used as a source of carbonaceous waste feedstock for the remainder of the method of the present invention will be understood to those skilled in the art and are all contemplated within the scope hereof.

In addition to different types and locations from which waste can be obtained for processing in accordance with the method of the present invention, the carbonaceous waste feedstock in its original format may have varying phases or varying liquid content which results in a modified approach being taken during the grinding step when the carbonaceous waste feedstock is ground into the ground feedstock of a particular particle size. For example it is contemplated that liquid carbonaceous waste feedstock could just as easily be processed in accordance with the method of the present invention, in which case slurry fluid may not need to be added to create a flowable slurry which could be processed in the heating step of the method, or hard or solid carbonaceous waste feedstock can also be used which could be ground into the appropriate particle size by grinding equipment and then comminuted or blended with a slurry fluid to produce the slurry of an appropriate flowable consistency in moisture content. Liquid or solid wastes are all contemplated to be within the scope of the present invention with the attendant modifications to the method and the processing equipment is a be obvious to those skilled in the art based upon the carbonaceous waste feedstock being used in a particular deployment of the method of the present invention.

Waste Removal Steps:

Various types of waste removal steps could be used in conjunction with the remainder of the system and method of the present invention to maximize the throughput and to yield recovered liquid hydrocarbon fraction 118 or other fractions of the highest possible purity or utility for sale or downstream use. Waste removal steps in respect of the carbonaceous waste feedstock are contemplated to in large part comprise steps involving one of two activities i.e. either removing certain undesirable components from the carbonaceous waste feedstock in advance of further processing, or alternatively adding desirable components to the carbonaceous waste feedstock to enhance the eventual heating reaction etc.

It is specifically contemplated that in certain embodiments of the method of the present invention, the waste removal step which might be undertaken in advance of the grinding of the carbonaceous waste feedstock would be the removal of undesirable components such as metal, glass or other contaminants from the carbonaceous waste feedstock. Removable of undesirable components from the carbonaceous waste feedstock will result in the eventual creation of a ground feedstock of the best possible consistency and the highest possible processability. Virtually any type of a purifying waste removal step to be applied to the carbonaceous waste feedstock as can be contemplated or understood by those skilled in the art of design of processes such as those outlined herein are again contemplated within the scope of the present invention—insofar as the removal of certain constituents or components from the carbonaceous waste feedstock might result in a carbonaceous waste feedstock that can either be ground more consistently when the ground feedstock of selected particle sizes created in the processing step, or will allow for the highest efficacy and throughput of the method or the production of a processed emulsion of the highest possible purity by the removal of those components early in the process.

As outlined elsewhere herein the waste removal step might also include either in addition to the removal of certain components or in the place of removal of certain components, the addition of one or more ingredients to the carbonaceous waste feedstock in advance of grinding—for example when a particular chemical agent or the like was required to be added to optimize the heating reaction or otherwise again results in the most efficient or efficacious operation of the system and method of the present invention. Again the addition of any particular type of added ingredient to the carbonaceous waste feedstock in the waste removal step in advance of the grinding is contemplated within the scope of the present invention, regardless of the ingredient or ingredients to be added.

Slurry Production:

The slurrying step 104 comprises the production of the feedstock slurry, by combining the ground feedstock of the selected particle size which results from the grinding step 102 with a quantity, if any is required, of the slurry fluid, to yield a feedstock slurry of the desired moisture content and consistency for further processing in the method outlined herein. If the carbonaceous waste feedstock which is ground in the grinding step 102 is sufficiently wet to be flowable or to yield a feedstock slurry simply from its grinding that is of a desired moisture content or consistency, no slurry fluid might be required. In other cases, where the ground feedstock was dry or otherwise was not of the desired moisture consistency or content to be properly flowable or to otherwise maximize the efficiency or efficacy of the heating reaction within the reactor at step 106, slurry fluid might be required to be added. The slurry fluid might be any number of different types of fluids including water. It is specifically contemplated however in accordance with the remainder of the method outlined herein that beyond initially “priming” the process with the use of clean slurry fluid, quantities of recovered liquid effluent fraction 114 from execution of the method of the present invention will be used as the slurry fluid which is used to constitute the feedstock slurry.

The desired characteristics of the feedstock slurry could vary, either based upon the handling characteristics which were desired i.e. to make the slurry flowable in a particular way, drier or wetter, or the like, or the desired characteristics of the feedstock slurry might also be impacted by the desired profile for the feedstock slurry to maximize the efficiency of the heating reaction within the heating step and the transfer reactor.

In terms of equipment required to be used in the slurrying step 104 this could be as simple as a reservoir into which ground feedstock is placed, and is blended therein with slurry fluid as required, or in other embodiments, the ground feedstock and the slurry fluid could even be blended inline as they were injected into the heat transfer reactor. Many different technical approaches and different types of equipment could be used, as will be obvious to those skilled in the art of industrial processing of this type, to allow physically for the creation of the desired feedstock slurry by the addition of a quantity of slurry fluid is required to the ground feedstock obtained in the processing step, and any such approaches are contemplated within the scope of the present invention.

Heat Source:

The heat transfer reactor as outlined includes a heat source, which is a generator of heat for application to the feedstock slurry within the heat transfer reactor during the heating step. Many different approaches could be taken to the heating of the feedstock slurry within the heat transfer reactor during the heating step, from the plumbing of heating pipes through the interior of the heat transfer reactor to allow for the pumping of heat transfer fluid therethrough, to the application of direct heat to the walls of the heat transfer reactor from open heat sources etc. Many different approaches to the provision of a heat source in respect of the heat transfer reactor will be understood to those skilled in the art of industrial equipment design in this area and any type of a heat source which is capable of safely and accurately applying the desired amount of heat to feedstock slurry contained within the heat transfer reactor during the heating step 106 is contemplated within the scope of the present invention.

Fluid heat exchange could be used to heat the heat transfer reactor and the feedstock slurry, or else electric or other types of heating elements within or outside of the heat transfer reactor could also be used—for example electric heating tape could even be used.

In the heat transfer reactor embodiment demonstrated in FIG. 3 and FIG. 4, the heat source comprises a fluid heat exchange jacket 312, through which heated fluid could be circulated around the outside of the outer heating tube 314, the outer heating tube 314 being manufactured of such material as to permit the translation of heat from heating fluid circulated through the fluid heat exchange jacket 312 into the feedstock slurry therein. The fluid heat exchange jacket 312 as shown is connected to a source of heating fluid 304, being a heated fluid reservoir from which heating fluid such as heated oil or the like can be circulated by a heating pump 310. The source of heating fluid 304 as shown would include a heat source to heat the heating fluid—i.e. the source of heating fluid 304 would be equipped with a heater or some type of a heat source to heat the heating fluid.

In other cases, such as the embodiment shown in FIG. 5, heating elements instead of the heating jacket could be used on the heat reactor to the same effect. Heating elements or other heat sources can be used to provide heat for application in a heat exchange application and all such approaches are contemplated herein.

In certain cases, the heating fluid reservoir might also include an agitator, similar to other components of the heat transfer reactor, to maximize the consistency of heating of the heating fluid therein and make the heating of the heating fluid operate as smoothly as possible. An active agitator 502 is shown in the embodiment of FIG. 5 for demonstrative purposes. It will be understood the the type of an agitator used in the source of heating fluid 304, if any, could be active or passive and take many forms and the use of any type of agitator in this component of the present invention is contemplated within the scope hereof.

Process Parameters:

It will be understood to those skilled in the art of the design of thermal reactions that equipment such as that outlined in this application that varying approaches and parameters could be imposed on the process to achieve the desired results. Specifically the parameters of the selected pressure, the selected heating temperature and the selected period of heating time could be adjusted dependent upon the feedstock and the desired outcome and any set of parameters or any set of ranges or settings of these variables will be contemplated to be within the scope of the present invention. It is specifically contemplated that in the context of feedstock slurry being municipal solid waste, the selected pressure for that type of a feedstock slurry might be in the range of 100 bar to 400 bar. As outlined however the pressure could be adjusted based upon the equipment and the desired outcome and any pressure range or pressure setting for the selected pressure is contemplated within the scope of the present invention. Similarly, the selected heating temperature could be any number of different levels but it is specifically contemplated with the equipment design outlined herein that heating the feedstock slurry to a selected heating temperature in the range of 275° C. to 425° C. is the likely operating range. Again any selected heating temperature will be contemplated or understood to be within the scope of the present invention.

Finally, the selected period of heating time could be selected or optimized based upon process outcomes it is specifically contemplated that the selected period of heating time could be in the range of five minutes to 120 minutes but it again will be understood that any selected heating time range could be used and is all contemplated within the scope hereof, with the necessary equipment adjustments to accommodate the heating time, pressure or temperatures selected.

Fractionation of Processed Emulsion:

FIG. 3 and FIG. 5 show an emulsion discharge holding tank 306 being a holding tank connected to the heat transfer reactor outside of the pressure-controlling discharge means or discharge valve 322. The emulsion discharge holding tank 306 as shown would hold the discharged processed emulsion and the processed emulsion could then be separated in the fractionation step 110. Many different technical approaches could be taken to the fractionation of the processed emulsion. The processed emulsion could be separated into the desired fractions mechanically, using different types of novel or known mechanical fractionation equipment or technologies, or different types of chemical or even electrical fractionation technologies could be used in certain circumstances to divide or refine the processed emulsion into the separated liquid, solid and waste fractions desired.

The liquid effluent fraction 114 is explicitly contemplated to primarily constitute water. Beyond using clean water to prime the system on startup, it is contemplated that the water which is used, and recovered as liquid effluent fraction 114, will be reused in the preparation of additional feedstock slurry in the method. Reuse of the water, or the liquid effluent fraction 114, in the subsequent slurrying of additional ground feedstock is a key element of the present invention. It is explicitly contemplated that very little clean water would need to be used as a supplement in the system of the present invention once the method was initiated, which results in economy in the method as well as in providing a significantly minimized environmental footprint to the method, insofar as clean water would not be used on an ongoing basis to make additional feedstock slurry once the method was initiated.

Again as outlined, an emulsion discharge holding tank 306 is shown in the Figures herein, but the processed emulsion when discharged from the heat transfer reactor via the discharge valve 322 could also be discharged straight into equipment related to the fractionation step rather than into a discharge holding tank as shown. Both such approaches are contemplated within the scope of the present invention. Any fractionation process which will result in the separation of the discharged processed emulsion into the desired fractions is contemplated within the scope hereof.

The equipment used in the fractionation step is not shown but will be understood to those skilled in the art of fluid or chemical processing and any combination of fractionation equipment or processes which could be used to separate the recovered processed emulsion into the three desired fractions—liquid effluent fraction 114, solid waste fraction 116 and liquid hydrocarbon fraction 118—and any type of fractionation processes or steps which could be used to conduct this separation are contemplated within the scope of the present invention.

Downstream Processing of Fractions:

As has been outlined elsewhere herein, and is strictly beyond the core focus of the method outlined herein in its detail, the recovered liquid hydrocarbon fraction, liquid effluent fraction, or solid waste fraction could each be subjected to further downstream processing or handling following the fractionation step of the method of the present invention. The downstream processing of these fractions could take place as a part of the system and method of the present invention, or at alternative or supplemental facilities to which those fractions could be rendered for following the completion of the fractionation step outlined herein.

The details of the downstream processing of the recovered fractions from the processed emulsion are not shown in detail in the Figures herein. At the core of this invention is the heat treatment of the feedstock slurry to yield the processed emulsion which can then be fractionated into the at least three desired fractions—further downstream processing might either take place in the same equipment or system of the method of the present invention, to further purify or process the liquid effluent fraction 114, the solid waste fraction 116 or the liquid hydrocarbon fraction 118, or the downstream processing of those fractions could take place with third parties or elsewhere apart from the system. The specifics of the downstream processing which might be applied will be understood to those skilled in the art of industrial chemistry and processing and again any type of downstream processing activity with respect to the recovered fractions, while primarily only considered proximate to the method of the present invention, is contemplated within the scope of the present invention insofar as specific downstream processing techniques to be applied to these fractions will not carry the overarching method sufficiently to depart from the intended scope of the claims outlined herein.

Any method of recovery of a liquid hydrocarbon fraction from carbonaceous waste feedstock as outlined herein which contains or comprises one or more downstream processing steps following the fractionation of the processed emulsion will be understood to be contemplated within the scope of the present invention.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A method of extraction of a liquid hydrocarbon fraction from carbonaceous waste feedstock, said method comprising:
a. in a grinding step, grinding carbonaceous waste feedstock into ground feedstock of a selected particle size;
b. in a slurrying step, creating a feedstock slurry by combining the ground feedstock with a slurry fluid as required to yield a feedstock slurry of a desired consistency and moisture content;
c. in a heating step, placing the feedstock slurry into a heat transfer reactor and heating the feedstock slurry to a selected heating temperature for a selected period of heating time while maintaining a selected pressure within the heat transfer reactor, following completion of which the feedstock slurry is processed emulsion which is discharged from the heat transfer reactor at a temperature between the selected heating temperature and ambient environmental temperature;
d. in a fractionation step, separating the processed emulsion which is held outside the heat transfer reactor at ambient pressure into three fractions namely a liquid hydrocarbon fraction, a liquid effluent fraction and a solid waste fraction;
wherein the slurry fluid used in the slurrying step consists primarily of liquid effluent fraction recovered from previous operation of the method.

2. The method of claim 1 wherein the liquid effluent fraction is primarily water.

3. The method of claim 1 wherein the liquid hydrocarbon fraction is repurposed without further processing, following the fractionation step.

4. The method of claim 1 wherein the liquid effluent fraction is repurposed without further processing, following the fractionation step.

5. The method of claim 1 wherein the solid waste fraction is repurposed without further processing, following the fractionation step.

6. The method of claim 1 wherein the liquid hydrocarbon fraction is subjected to further downstream processing following the fractionation step.

7. The method of claim 1 wherein the solid waste fraction is subjected to further downstream processing following the fractionation step.

8. The method of claim 1 wherein the liquid effluent fraction is subjected to further downstream processing following the fractionation step.

9. The method of claim 1 further comprising agitating the feedstock slurry within the heat transfer reactor during the heating step.

10. The method of claim 9 wherein the agitation of the feedstock slurry within the heat transfer reactor is done by at least one passive agitator therein.

11. The method of claim 10, wherein the passive agitator comprises flighting mounted inside the heat transfer reactor.

12. The method of claim 9 wherein the agitation of the feedstock slurry within the heat transfer reactor is done by at least one active agitator therein.

13. The method of claim 1 wherein the selected pressure is in the range of 100 bar to 400 bar.

14. The method of claim 1 wherein the selected heating temperature is in the range of 275 degrees Celsius to 425 degrees Celsius.

15. The method of claim 1 wherein the selected period of heating time is in the range of 5 minutes to 120 minutes.

16. The method of claim 1 wherein the carbonaceous waste feedstock is comprised primarily of at least one of municipal solid waste, industrial waste, commercial waste or institutional waste.

17. The method of claim 1 further comprising a waste removal step in advance of the grinding step wherein untreatable items selected from the group of metals, rocks, glass, and nontreatable waste are removed from the carbonaceous waste feedstock in advance of grinding.

18. The method of claim 1 wherein the heating step is conducted in a batch mode.

19. The method of claim 1 wherein the heating step is conducted in a continuous feeding mode.

20. The method of claim 1 wherein the feedstock slurry comprises ground feedstock without added slurry fluid, where the moisture content of the ground feedstock is sufficient without the addition of slurry fluid.

21. The method of claim 1 wherein the heat transfer reactor comprises a tube reactor with an intake and a discharge, and a heating fluid jacket around at least a portion thereof to heat the contents of the tube reactor.

22. The method of claim 1 wherein the heat transfer reactor comprises:
a. an outer heating tube having an outer tube length and outer tube diameter, and a closed outer distal end and a discharge end;
b. an inner heating tube having an inner tube length and an inner tube diameter, and an injection end and an open inner distal end, the inner volume of the inner heating tube comprising an inner heating reservoir, and wherein:
i. the inner tube diameter is smaller than the outer tube diameter, the space between the inner heating tube and the outer heating tube being the outer heating reservoir; and
ii. the inner heating tube is mounted axially inside of the outer heating tube with the injection end of the inner heating tube near the discharge end of the outer heating tube, and the inner distal end of the inner heating tube in proximity to the inside of the outer distal end of the outer heating tube;
c. pressure-controlling injection means connected to the injection end of the inner heating tube through which feedstock slurry can be injected from a source of feedstock slurry into the inner heating reservoir;
d. pressure-controlling discharge means connected to the discharge end of the outer heating tube from which processed emulsion can be discharged from the outer heating reservoir, wherein the pressure-controlling injection means and pressure-controlling discharge means cooperate to maintain the selected pressure of feedstock slurry within the heat transfer reactor during the heating step; and
e. a heat source in operative communication with the outer heating reservoir whereby heat can be applied to feedstock slurry within the heat transfer reactor.

23. The method of claim 22 wherein the heat source comprises a fluid heat exchange jacket around the exterior of at least a portion of the outer heating tube, wherein a heating fluid circulated therethrough will transfer heat to the outer heating tube and to the feedstock slurry within the heat transfer reactor.

24. The method of claim 23, wherein the fluid heat exchange jacket is operatively connected to a heated fluid reservoir via a pump for circulation therethrough and reheating of the heating fluid on recirculation back to the heated fluid reservoir.

25. The method of claim 22 wherein the heat source comprises heating elements attached to the outer heating tube.

26. The method of claim 22 wherein the source of feedstock slurry comprises a slurry reservoir.

27. The method of claim 22 wherein the outer tube diameter is at least four inches.

28. The method of claim 22 wherein the pressure-controlling injection means comprises a pumping apparatus and an injection valve.

29. The method of claim 22 wherein the pressure-controlling discharge means comprises a discharge valve.

30. A heat transfer reactor for use in a method of extraction of a liquid hydrocarbon fraction from carbonaceous waste feedstock where the method comprises in a heating step placing feedstock slurry of a desired consistency and moisture content into a heat transfer reactor and heating the feedstock slurry to a selected heating temperature for a selected period of heating time while maintaining a selected pressure within the heat transfer reactor, following completion of which the feedstock slurry is processed emulsion which is discharged from the heat transfer reactor at a temperature between the selected heating temperature and ambient environmental temperature, for separation in a fractionation step separating the processed emulsion which is held outside the heat transfer reactor at ambient pressure into three fractions namely a liquid hydrocarbon fraction, a liquid effluent fraction and a solid waste fraction, said heat transfer reactor comprising:
a. an outer heating tube having an outer tube length and outer tube diameter, and a closed outer distal end and a discharge end;
b. an inner heating tube having an inner tube length and an inner tube diameter, and an injection end and an open inner distal end, the inner volume of the inner heating tube comprising an inner heating reservoir;
c. pressure-controlling injection means connected to the injection end of the inner heating tube for connection to a source of feedstock slurry and through which feedstock slurry can be injected into the inner heating reservoir;
d. pressure-controlling discharge means connected to the discharge end of the outer heating tube; and
e. a heat source in operative communication with the outer heating reservoir whereby heat can be applied to feedstock slurry within the heat transfer reactor;
wherein:
i. the inner tube diameter is smaller than the outer tube diameter, the space between the inner heating tube and the outer heating tube being the outer heating reservoir;
ii. the inner heating tube is mounted axially inside of the outer heating tube with the injection end of the inner heating tube near the discharge end of the outer heating tube, and the inner distal end of the inner heating tube in proximity to the inside of the outer distal end of the outer heating tube;
iii. feedstock slurry injected into the inner heating reservoir via the injection end will exit the inner heating reservoir under pressure and be pressured back along the outer heating reservoir towards the discharge end; and
iv. the pressure-controlling injection means and pressure-controlling discharge means cooperate to maintain the selected pressure of feedstock slurry within the heat transfer reactor during the heating step.

31. The heat transfer reactor of claim 30 wherein the heat source comprises a fluid heat exchange jacket around the exterior of at least a portion of the outer heating tube and connected to a source of heating fluid, wherein a heating fluid circulated therethrough will transfer heat to the outer heating tube and to the feedstock slurry within the heat transfer reactor.

32. The heat transfer reactor of claim 30 wherein the heat source comprises heating elements attached to the outer heating tube.

33. The heat transfer reactor of claim 30 wherein the outer tube diameter is at least four inches.

34. The heat transfer reactor of claim 30 wherein the pressure-controlling injection means comprises a pumping apparatus and an injection valve.

35. The heat transfer reactor of claim 30 wherein the pressure-controlling discharge means comprises a discharge valve.
